(19) United States
(12) Patent Application Publication
(10) Pub. No.: US 2024/0148107 A1
(43) Pub. Date: May 9, 2024

(54) CUSHIONED ARTICLES

(71) Applicant: CARBON AIR LIMITED, Greater Manchester (GB)

(72) Inventors: John FitzGerald COAKLEY, Derbyshire (GB); Thomas Anthony RYAN, Richmond (GB)

(21) Appl. No.: 17/768,735

(22) PCT Filed: Oct. 14, 2020
(86) PCT No.: PCT/GB2020/052580

§ 371 Date: Apr. 13, 2022

(30) Foreign Application Priority Data
Oct. 14, 2019 (GB) 1914866.7

(51) Int. Cl. A43B 13/20

(52) U.S. Cl. CPC A43B 13/20

(57) ABSTRACT

The invention relates to cushioned articles selected from items of footwear, cushioned seating, pillows, mattresses, beds, with air or gas pockets, inflatable air beds, orthopaedic support devices, orthotic insoles, soft robotic devices, safety headwear, safety body wear, body armour, crumple zones in vehicles, pneumatic deformable crash structures or barriers, and spring systems with multiple spring rates, which have improved compliance and shock absorbance characteristics. The cushioned articles include one or more cushioning elements which comprise pressurised gas contained within one or more primary pressurised gas storage chambers, wherein the bulk modulus, K, of the pressurised gas inside said pressurised chambers is <1. The pressurised gas in such cushioned articles is preferably in fluid communication with one or more gas adsorbent materials.

### FIELD OF THE INVENTION

The present invention relates to improvements in air cushioning and, most specifically, to a wide range of cushioned articles which benefit from such improvements.

### BACKGROUND OF THE INVENTION

It is well known to include cushioning elements, which comprise air chambers, in the construction of a wide range of cushioned articles such as seating, mattresses, footwear, safety wear, soft robotic devices etc. as a means to provide comfort, body support, resilience and impact shock absorbance both to the user of the article and to the article itself.

As a specific example, many dozens of footwear companies have developed technologies over the past century to capture the benefits of using pneumatic air chambers (cushioning elements) in the soles and undersoles of footwear. Air chambers are attractive because they are extremely lightweight, achieve a soft, cushioning effect and the air that acts as a spring within the structure, whether compressed or not, does not wear out or suffer reduced performance over time, unlike most elastomeric material alternatives.

Cushioning elements, that utilise one or more primary pressurised gas chambers (for example, air chambers), have the potential to achieve cushioned articles with improved shock isolation, and in the case of footwear, for example, this is required when the foot, and particularly the heal, makes a hard impact with the ground during running or jumping. Typical gas-filled chambers are constructed from a resiliently (elastically) deformable polymer material and these material properties operate in conjunction with the pressurised gas inside the chamber, to allow resilient deflection of the chamber and shock isolation; this is akin to a inflated bicycle innertube. WO96/39885 describes one such a system in which gas-filled bladders are constructed from a resiliently deformable, gas transmission resistant polyester polyol based polyurethane membrane which has good flexibility and durability.

High levels of shock isolation are achieved when a cushioning element, (for example within the sole of a shoe or within a seating cushion or mattress) comprises one or more deep primary pressurised gas chambers which allows a considerable length of travel in compression in response to a heavy shock. The duration of the shock event is therefore lengthened, and the intensity of the jolt reduced. Damping materials are often brought into play adjacent to or even within such primary pressurised gas chambers to dissipate energy from such an impact as the primary pressurised gas chamber approaches peak compression. Notwithstanding these benefits, it is undesirable in all applications to make the primary pressurised gas chambers too deep, firstly because this will make the cushioned article unnecessarily large, potentially cumbersome to use and aesthetically less elegant (e.g. in the case of footwear, the sole would be overly thick), and secondly, the deeper the compressed gas chamber the more compliant it will be, i.e. the easier it will be for it to undergo elastic deformation when subjected to an applied force. In many cushioned articles, for example, mattresses, seat cushions, footwear and soft robotic devices, the use of a cushioning element comprising one or more primary pressurised gas storage chambers which are too compliant will fail to provide the desired level of support to the user. Some of these issues appear to be addressed, at least in part, by the cushioning material disclosed in WO2008/083408A2. In the arrangement described, a cushioning material comprising a plurality of air-filled chambers are constructed from an elastically deformable polymeric sheet material. A further material or device, such as a woven or non-woven fabric, paper, polymeric material, polymeric gel, a gel-filled balloon device, a spring or foamed polymeric material, may be disposed in one or more of the chambers to enhance the shock-absorbing characteristics of the cushioning material. The cushioning and shock absorbing characteristics of these described cushioning materials rely on the elastic deformability of the polymeric sheet material from which the air-filled chambers are constructed, in combination with the air inside, and also, when a further material is included, the inherent elastic deformability of the polymeric material, gel materials and spring.

In the specific case of a cushioning element comprising one or more primary pressurised gas storage chambers within the sole of a trainer or sports shoe, when the wearer runs or undertakes fast action, it is important to preserve “feel” in the sole of the foot and to maximise rebound efficiency in running by keeping the sole reasonably firm overall. Lateral and axial stability are also critical for the foot, heal and ankle, and excessively soft air chambers underneath or surrounding the sole or heal will allow excessive roll, risking the wearer losing fine control or worse, “going over on their ankle”. However, a major outstanding problem with cushioned articles known to date, is a lack any means which enable the degree of cushioning and shock absorbance provided to the user, to be responsive to the level and/or duration of the shock event.

There is therefore a need for a technology which controls the stiffness of the cushioning elements that are included in cushioned articles (such as seating, mattresses, footwear, soft robotic devices or safety wear etc.) during normal use, and which at the same time ensures that the level of compliance- or softness- of such cushioning elements during major shock events is maintained, thereby to provide a high level of cushioning when it is most needed.

Further there is a need for technology which allows for the compliance response of separate air cushioning elements used within a cushioned article at a similar pressure, to be independently controlled one from the other, and for this control to be effected easily and reliably.

Additionally, there is a need for technology which provides a cushioned article with improved rebound characteristics compared against a similar article with a known cushioning element.

Moreover, there is a need for technology which provides a cushioned article that has one or more cushioning elements which, when subjected to a high sudden impact event, have a lower resonant frequency, and which experience a reduced shock transmissibility as a result of both large and mild shock events, compared with the resonant frequency and shock transmission of known cushioning elements.

Finally, there is a need for technology which allows the efficient and cost-effective manufacture of cushioned articles that utilise the improvements in air cushioning proposed by the present Applicant, and which produces cushioned articles which are robust and fit for purpose.

In the case of gas-filled cushioning element of the type described above, it is possible to determine its stiffness (or compressibility) by studying the elastic properties of the pressurised gas inside it. The term “static bulk modulus” (represented by the constant “K”) can be used as a measure of the ability of the pressurised gas to withstand changes in volume when under compression on all sides, and is equal to the quotient of the pressure increase inside the cushioning element as a result of applying a pressure to the outside surface of the cushioning element, divided by the resulting relative decrease of the volume.

This is also represented by the equation:

$$K = - {V}_{0} \frac{dP}{dV}$$

where V₀ is the initial volume of a fixed mass of gas inside the cushioning element, dP is the change in pressure (the difference between the original pressure and the new pressure as a result of the pressure applied to the outside surface of the cushioning element), and dV is the change in volume which is caused by the action of the applied pressure.

The static bulk modulus, K, for air, as for an ideal gas, is typically reported to be equal to the static pressure. (101.3 kPa at standard pressure). For convenience, henceforth a value normalised by the static pressure is used:

$${K}_{norm} = \frac{K}{{P}_{0}}$$

Thus, the normalised bulk modulus of a sealed air volume would normally have a value of around 1.

As detailed below, the fraction of the air volume occupied by an adsorptive material, for example activated carbon, inside cushioning elements which form part of the cushioned articles of the present invention, is able to achieve a result of <1, preferably ≤1.95, highly preferably ≤0.8 and highly preferably between 0.5 to 0.8.

The dynamic bulk modulus relates to the elasticity of the gas when subjected to a rapid compression (i.e. with an impact frequency) where heat is not exchanged with its surroundings, and so the pressure build-up in the sealed cavity is higher than for the static case. This scenario is known as an adiabatic process, and is particularly relevant to the sole of a running shoe which, in use, will be impacted repeatedly and rapidly with each stride and a pressurised gas filled cushioning element within the sole will be repeatedly compressed. Each compression of the cushioning element will generate heat which in turn will cause the gas inside the cushioning element to expand and its pressure to increase. The result experienced by the wearer of the running shoe, is that the shoes stiffen during impacts, suffering a reduction in the level of cushioning, and thereby affecting shoe comfort.

The normalised dynamic bulk modulus of air is >1 and is typically reported to be around 1.4 (equal to the heat capacity ratio of air).

The present applicant has found a way to control the dynamic bulk modulus of a pressurised gas inside a cushioning element. Specifically, the present invention provides a cushioned article comprising one or more cushioning elements which comprise pressurised gas contained within one or more primary pressurised gas storage chambers, wherein the dynamic bulk modulus of the pressurised gas when in use within an impact frequency range from 1 Hz to 50 Hz, is lower than the dynamic bulk modulus that would be expected for the pressurised gas in a cushioning element. For example, the expected normalised dynamic bulk modulus of air is, as above, 1.4, however, the fraction of the air volume occupied by an adsorptive material such as activated carbon inside cushioning elements which form part of the cushioned articles of the present invention is able to achieve a result of <1, preferably ≤1.95, highly preferably ≤0.8 and highly preferably between 0.6 to 0.8

These figures are impossible to achieve using any normal, high porosity fill material; which such materials may reduce the adiabatic rise in stiffness by acting as a heat sink, and this may reduce the dynamic bulk modulus slightly, the value for K is always above 1.

Therefore, the present invention provides a cushioned article selected from footwear, cushioned seating, pillows, mattresses, beds, with air or gas pockets, inflatable air beds, orthopaedic support devices, orthotic insoles, soft robotic devices, safety headwear, safety body wear, body armour, crumple zones in vehicles, pneumatic deformable crash structures or barriers, and spring systems with multiple spring rates, comprising one or more cushioning elements comprising pressurised gas contained within one or more primary pressurised gas storage chambers, wherein the nomalised bulk modulus of the pressurised gas (preferably comprising air, further preferably comprising nitrogen and very preferably comprising carbon dioxide) within one or more primary pressurised gas storage chambers, K, is <1.

Advantageously, the pressurised gas contained within the one or more primary pressurised gas storage chambers will have a nomalised bulk modulus, K, of <1 across the range of frequencies from 0.1 Hz up to 50 Hz, preferably across the range of frequencies from 1 Hz to 50 Hz, particularly preferably across the range of frequencies from 2 Hz to 50 Hz and especially preferably across the range of frequencies from 0.5 Hz to 10 Hz.

In the present invention, the normalised bulk modulus of the pressurised gas inside the pressurised gas chamber of <1 is achieved by the pressurised gas alone, with no assistance or no component of the bulk modulus, being as a result of the modulus of the material used to construct the pressurised gas chamber. Ideally, the pressurised gas chambers will be constructed from non-resiliently deformable material, or otherwise constructed in a way which means that they are not resiliently deformable.

Further advantageously, the above described cushioned article according to the present invention comprises one or more cushioning elements comprising pressurised gas contained within one or more primary pressurised gas storage chambers, wherein the pressurised gas is in fluid communication with one or more sources of gas adsorbent material.

The term “adsorbent material” used herein refers to a single adsorbent material as well as to a mixture of several different adsorbent materials. A suitable adsorbent material is must exhibit the adsorption and desorption kinetics needed (the adsorption/desorption must be fast and efficient enough) to ensure that a reduction in dynamic bulk modulus is obtained. Ideally, the adsorbent material is non resiliently deformable, highly porous, preferably highly microporous, and is capable of adsorbing at least some of the pressurised gas contained within the one or more primary pressurised gas storage chambers.

The adsorbent material will comprise any one or more materials selected from one or more zeolites, one or more microporous organic polymer (MOP) materials and one or more activated carbon materials.

The applicant has observed that even though a material may have a fairly high specific (BET) surface area, it will not necessarily achieve the required dynamic bulk modulus value. Certain synthesised zeolites (e.g. Zeolite 13X) are materials which can have a specific (BET) surface area of around 590 m²/g, however, although these characteristics are highly suitable when the Zeolite 13X is used as a mioroporous molecular sieve to adsorb and trap organic molecules or contaminants, this material is not able to provide efficient desorption of the adsorbed materials, taking many seconds, minutes or hours to release the adsorbed gas.

In one embodiment of the present invention, therefore, the adsorbent material comprises a zeolite materials with a specific (BET) surface area in excess of 600 m²/g, preferably of at least 800 m²/g, further preferably at least 1000 m²/g, and still further preferably at least 1500 m²/g, up to a maximum of 10,000 m²/g.

In another embodiment, the adsorbent material comprises a non-resiliently deformable foam material produced by polymerising a High Internal Phase Emulsion to produce a polyHIPE material and then crosslinking this for produce a foam material that has a porous reticulated and non-resiliently deformable structure. A particularly suitable polyHIPE material is poly-dichloroxylene (P-DCX).

In a preferred embodiment, the adsorbent material comprises one or more activated carbon materials, for example powdered or granular activated carbons made from a carbonaceous source material. Typically, activated carbon materials have small low volume pores and a high surface area. For reasons which are not currently well understood, the present applicant has found that activated carbon materials are particularly suited to achieving the required adsorption/desorption kinetics which to ensure that the bulk modulus, K, of the pressurised air inside the chambers is <1. Any activated carbon material appears to be suitable to be used to obtain the required bulk modulus results, however, the (BET) surface area of the activated carbon material is generally known to be >400 m² /g. Preferably the (BET) surface area of the activated carbon material will be in excess of 600 m² /g, further preferably at least 800 m² /g, particularly preferably at least 1000m² /g, and still further preferably at least 1500 m² /g, up to a maximum of 10,000 m² /g.

It is also believed that the pore size of the adsorbent material may be important for efficient gas adsorption/desorption kinetics. Thus, it is preferable that the gas adsorbent material comprises pores of which at least 50%/wt, (preferably at least 70%/wt, further preferably at least 80%/wt, and very preferably at least 95%/wt), have a mean diameter of to 50nm and preferably a mean diameter of to 10nm. Further preferably, the gas adsorbent material used in the present invention will have an average pore diameter of 2 nm. Naturally, to be an effective gas adsorbent material its pores need to be available for gas adsorption; an otherwise suitable adsorbent material with blinded pores, for example as a result of being embedded or encapsulated in a polymer composition for example used to make the gas storage chambers, does not fall within the scope of the present invention. Therefore, the abovementioned pores refer to the pores in the adsorbent material that are available for gas adsorption.

The adsorbent material may be used in solid form, for example as loose granules, powder or as a self-supporting monolith (e.g. a free-standing solid mass). A monolith can be conveniently made by admixing granular or powdered adsorbent material with a range of binders (such as an epoxy resin or some other cohesive material), moulding the mixture and then curing (for example by heating and/or irradiation). Care must be taken during the production of the monolith structure not to blind the pores of the adsorbent material which would make it incapable of adsorbing gas and achieving a reduction in dynamic bulk modulus, as described above. The resulting self-supporting monolith may be rigid, but it may also be flexible if a highly elastomeric binder such as latex is used, preferably in conjunction with reinforcing fibres made from high tensile plastics such as aramid and/or carbon fibres or glass fibres. A preferred adsorptive material is a self-supporting monolith comprising activated carbon.

Alternative solid forms of adsorbent material include a felt, an un-woven fibre, a woven fibre or an open-cell foam substrate, which is impregnated with the adsorbent material described above (preferably in powdered form) which adsorbent material in use, reduces the gas dynamic bulk modulus, as described above, . An example would be activated carbon cloth, such as sold under the registered UK trade mark Zorflex by Chemviron Carbon Limited.

Preferably, the adsorbent material is not a liquid material, although the present invention includes a solid adsorbent material contained within a liquid material to thereby provide a porous liquid or porous high viscosity fluid.

In operation, the one or more primary pressurised gas storage chambers are preferably closed to the ambient pressure conditions and are capable of undergoing elastic deformation when subjected to an applied force, for example when a person is leaning or lying on, being supported by or wearing the cushioned article, or when the cushioned article is a soft robotic device in operation, or when crumple zones or crash structures etc. are subjected to impact forces. Preferably, the one or more primary pressurised gas storage chambers are formed by a pneumatic encapsulation material with an inner wall surface and an outer wall surface, wherein the inner wall surface is preferably non-resilient. Highly preferably, the primary pressurised gas storage chambers are non-resiliently deformable.

In an extremely preferred example of the present invention, the one or more cushioning elements provide, or alternatively are adapted to provide, one or more aesthetic and/or functional features to the cushioned article. The aesthetic and/or functional features may be provided to the cushioned article as a result of the outer surface of the one or more primary pressurised gas storage chambers being made from (or being designed or adapted to carry) a material with the desired aesthetic and/or functional characteristics. This may be a particular fabric which, for example, imparts wear resistance, colour, design, pattern, feel, warmth, resilience, comfort, tread pattern and so on to the cushioned article. In a particularly preferred embodiment, the present invention provides a cushioned article as described above, in which the outer wall surface of the pneumatic encapsulation material forms a portion of the exterior surface of the cushioned article.

The role of the adsorptive material is to reduce the spring rate of the pressurised gas contained inside the above described one or more primary pressurised gas storage chambers, whilst the pressure inside the gas storage chamber remains constant. The adsorptive material does not itself compress or deform in response to an applied load. When one or more primary pressurised gas storage chamber compresses (or is compressed by the user of the cushioned article), a portion of the pressurised gas is adsorbed by the adsorbent material and the force inside the storage chamber builds up more slowly than it would do in the absence of an adsorbent material. This in turn, causes the one or more primary pressurised gas storage chambers to compress further for a given applied force making them behave as if they have a greater physical volume and as if they were softer relative to a known pressurised chamber in the absence of adsorbent material. The result is a cushioned article which enjoys a controlled increase in compliance, an improved shock absorbency and enhanced user comfort.

Further advantageously, as demonstrated below, the use of an adsorbent material allows the pressure of the gas within a primary pressurised gas storage chamber to be increased such that it will afford the same degree of impact isolation as a gas at lower pressure, but will do so with a significant increase in potential energy stored in the gas, thereby resulting in improved rebound characteristics. The internal pressure within the one or more primary pressurised gas storage chambers is from just above the ambient atmospheric pressure up to 5 bar, preferably around 2.5 bar, and further preferably up to around 3.5. At higher pressures, it is envisaged that the presence of the adsorbent will allow improved shock adsorption (compared with shock adsorption in the an absence of an adsorbent material) and will achieve this for both large and small amplitude events without changing the compliance and without changing the general feel in normal usage. All of the one or more primary pressurised gas storage chambers may have the same internal pressure, but this need not be the case. Further, the spring rate of the gas inside the primary pressurised gas storage chambers (and hence the spring rate of the cushioning elements) may be the same for all, but again this need not be the case. The gas held within the one or more primary pressurised gas storage chambers is preferably selected from air and carbon dioxide. Air is particularly preferred.

The adsorptive (adsorbent) material may be disposed (i.e. “included”) within at least one of the one or more gas storage chambers of the cushioning element and will preferably occupy up to 35%, or around one third, of the volume of the storage chamber. Preferably, and especially when the adsorbent material is in fine powder or granular form, the adsorbent material is contained behind a flexible poro-elastic membrane or some other permeable membrane or a non-permeable membrane which comprises a degree of microperforation. Preferably, such a membrane is adhered to the inner wall surface of the primary pressurised gas storage chamber. Further preferably, adsorbent material is not disposed on a load bearing surface and preferably it is disposed away from any such load bearing surface.

Most preferably, the adsorbent material is disposed within one or more secondary chambers. Such a secondary chamber may be sited within a primary pressurised gas storage chamber which contains the pressurised gas with which they are in fluid communication, or the secondary chamber may be located separately from (although preferably adjacent to, or at least near, to) the primary pressurised gas storage chamber. For example, when the cushioned article is an item of footwear, the one or more secondary chambers may be located within the heel, outer sole or mid sole), and accessible to the pressurised gas held by the one or more of the primary pressurised gas storage chambers via one or more gas channels. The present invention may also include a secondary chamber containing an adsorbent material which is sited centrally (for example in an item of footwear, underneath the heal) and radially linked, via one or more gas channels, to the primary pressurised gas storage chamber or chambers which contain the pressurised gas with which the adsorbent material is in fluid communication. In contrast to the one or more primary pressurised gas storage chambers, the secondary chambers do not typically compress when a force is applied to the cushioning element of a cushioned article.

The cushioned article may employ a series of cushioning elements each comprising one or more primary pressurised gas storage chambers in the form of “bubbles” or “bladders”.

Further, the fluid communication between the pressurised gas contained within the one or more primary pressurised gas storage chambers and the adsorbent material may be restricted or blocked by valves or restrictions to control the compressibility of the primary gas storage chambers. It is also possible to use different amounts of adsorbent material to achieve varying levels of compressibility in different primary pressurised gas storage chambers being held at the same pressure, to achieve a gradient of compressibility across the one or more primary pressurised gas storage chambers of similar pressure and load bearing capacity.

Preferably, the cushioned article of the present invention will further comprise damping or shock absorber means, for example the flexible poro-elastic membrane may be non-porous but feature one or more perforation or filtered orifice to facilitate controlled fluid communication in a way that achieves orifice damping of the pressurised gas. Alternatively, the adsorbent material may comprise a high-viscosity microporous fluid or gel which acts as a damping element in extreme compression. As described above, the compliance of the gas in short compressions will be changed in the presence of an adsorbent, but granular or viscous fluid adsorbents may also act as a physical damper (as a discrete damping or “bump stop” element due to size/shape of the material) at the end of a long compression, for example as a result of heavy or large shock events.

Further preferably, at least two of the cushioning elements used in the cushioned article of the present invention are in fluid communication with each other, preferably via one or more of their respective primary pressurised gas storage chambers. Ideally, the present invention includes selective control means to selectively control the fluid communication between any of the one or more cushioning elements. Envisaged selective control means include a valve means operable between open and closed positions, and provided in association with one or more of the cushioning elements, in order to permit or restrict pressurised gas to flow between said cushioning elements.

Additionally, it is preferable that at least one of the cushioning elements is in exclusive fluid communication with one or more sources of adsorbent material. In the case where more than one source of adsorbent material is used, they may comprise the same or a different composition of adsorbent materials. A “different” adsorbent material includes a material that has a different chemical composition or one which has the same chemical composition, but which uses a different amount and/or in a different physical form and/or is a different grading of material.

The cushioning elements may comprise one or more primary pressurised gas storage chambers of similar or different sizes or volumes and they may operate at similar or different pressures. In cushioning articles featuring multiple sealed primary pressurised gas chambers with similar heights, volumes and/or operating at similar pressures, the disposal of varying quantities of adsorptive material may be used to tune the spring rate of gas in each primary pressurised gas storage chamber, thereby allowing the compressibility of the chambers to vary across the cushioned article and allowing zonal control of compliance across cushioned article laterally, radially or longitudinally. Advantageously, deeper or softer compliance and shock absorbency can be afforded in regions of the cushioned article which will be subjected in use to higher impact forces. For example, in an article of footwear these improvements will typically be required at the heel, particularly when downhill running.

The present invention is particularly useful to provide a cushioned article which comprises an array, preferably a layered array, of two or more cushioning elements with primary pressurised gas storage chambers of similar dimensions and pressures but which may comprise a graded index of compliance which can be achieved by progressively increasing adsorptive material fill factor or changing the (chemical or physical) composition of the adsorption material. Such layered arrays may achieve extremely high levels of shock absorbency in any of the applications described above, but particularly in applications such as helmets, body armour, crumple zones in vehicles and air spring systems. Multiple cushioning elements with different spring rates can be tuned to act in a non-linear or progressive way according to the degree of linear excursion. Highly desirably, the cushioning elements will comprise a single dimensional array (a sheet) of multiple primary pressurised gas storage chambers, preferably in the form of “bubbles” or “bladders”, which contain, or are in fluid communication with, one or more sources of adsorbent material, and which are constructed, for example, from one or more selected from a durable plastics material, a metalized plastics material, and a thin metal foil material. Cushioned articles which are required to withstand extreme shocks/impact forces may comprise several layers of such heavy-duty augmented bubble wrap. The cushioning elements may be provided with a graded index of adsorbent fill or a graded index of adsorbent characteristics, with the most compressible layer being held on the outermost surface, facing any potential impact.

In another example, the present invention provides a cushioned ski boot, snowboard boot or walking boot, comprising one or more cushioning elements. Preferably, the one or more cushioning elements are embedded within gas cushion collars located inside the boot to provide support to the boot wearer (for example, their foot, heel or lower leg) whilst skiing, snowboarding or walking.

The present invention additionally provides a cushioned article comprising an external surface and an internal structure, wherein the internal structure is adapted to receive one or more cushioning elements which comprise one or more primary pressurised gas storage chambers which are preferably closed to the ambient pressure conditions and are preferably capable of undergoing elastic deformation when subjected to an applied force, wherein the one or more primary pressurised gas storage chambers are preferably formed by a pneumatic encapsulation material that has an inner wall surface which is preferably non-resilient and an outer wall surface that is preferably adapted to provide one or more aesthetic and/or functional features to the cushioned article, and further wherein a primary pressurised gas storage chamber of at least one cushioning element is in fluid communication with one or more sources of adsorbent material.

A highly preferred cushioned article of the present invention is an item of footwear.

### BRIEF DESCRIPTION OF THE DRAWINGS

The present invention will now be described with reference to the following figures in which:

FIG. 1 shows a diagram of the test cylinder rig used in Examples 1 and 2;

FIG. 2 shows a graph of force (N) within a primary pressurised gas storage chamber against primary chamber compression distance travelled (mm), to illustrate the effect of with and without an absorbent material disposed within a compressed primary pressurised gas storage chamber, showing the results obtained in Experiment 1.

FIG. 3 shows a graph of stiffness (N/mm) versus compression (mm) showing the results obtained in Experiment 1.

FIG. 4 shows a graph of force (N) within a primary pressurised gas storage chamber against primary chamber compression distance travelled (mm), to illustrate the effect of the presence and the absence of an absorbent material disposed within a compressed primary pressurised gas storage chamber, showing the results obtained in Experiment 2.

FIG. 5 shows a graph of stiffness (N/mm) versus compression (mm) showing the results obtained in Experiment 2.

FIG. 6 shows a side view of a lace-up shoe which includes several cushioning elements according to the present invention formed within its heel and sole.

FIGS. 7A, 7B and 7C show three different side cross-section views taken in the vertical plane which is parallel with the longitudinal axis of the shoe structure shown in FIG. 6 for each of three possible versions of the structure of the sole.

FIG. 8A shows a cross-section through the heel region of the sole of the shoe shown in FIG. 6, the section being taken in the vertical plane through the heel region of the shoe and parallel with the transverse axis of the shoe, and shows two independent cushioning elements, each of which comprises a primary pressurised gas storage chamber that contains adsorbent material.

FIG. 8B shows a similar cross-section to that depicted in FIG. 8A but shows an alternative version of the heel structure to that shown in FIG. 8A, with a secondary chamber filled with adsorbent material positioned between and fluidly communicating with two cushioning elements which each comprise a primary pressurised gas storage chamber that contains adsorbent material.

FIG. 8C shows a similar cross-section to that depicted in FIGS. 8A and 8B but of a second alternative version of the heel structure shown in FIG. 8A, with a secondary chamber filled with adsorbent material positioned between and fluidly communicating with two cushioning elements which each comprise a primary pressurised gas storage chamber which is empty of adsorbent material.

FIG. 9 shows an exploded perspective view of yet another alternative version of a cushioning element which is suitable for positioning within the heel region of a shoe.

FIG. 10A shows a graph of the change in pressure (dP) within a primary pressurised gas storage chamber against the frequency (Hz) of impact events for the results obtained in

Experiment 3.

FIG. 10B shows a graph of the quotient of bulk modulus (K) and the original pressure (Po) against the frequency (Hz) of impact events for the results obtained in Experiment 3

The concepts of the static and dynamic bulk modulus of a fluid are very well known in the art, since this is a fundamental quantity used in many areas of engineering, and it is extremely common practice to measure or model the stiffness of an air spring system generally in order to determine the static and dynamic bulk modulus of the fluid concerned. The present applicant has devised the test rig and experimental procedure described below to provide a convenient means by which to determine bulk modulus of the test materials.

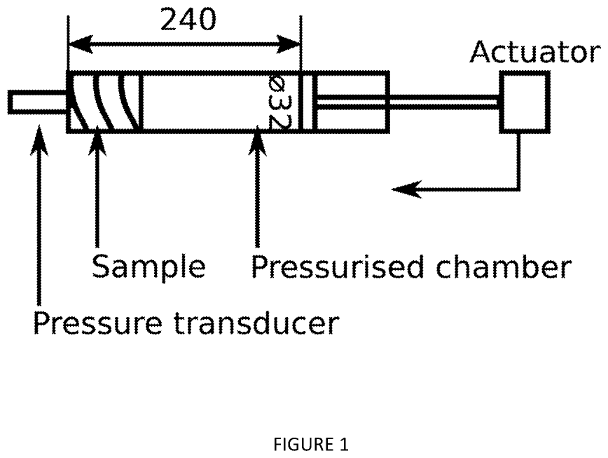

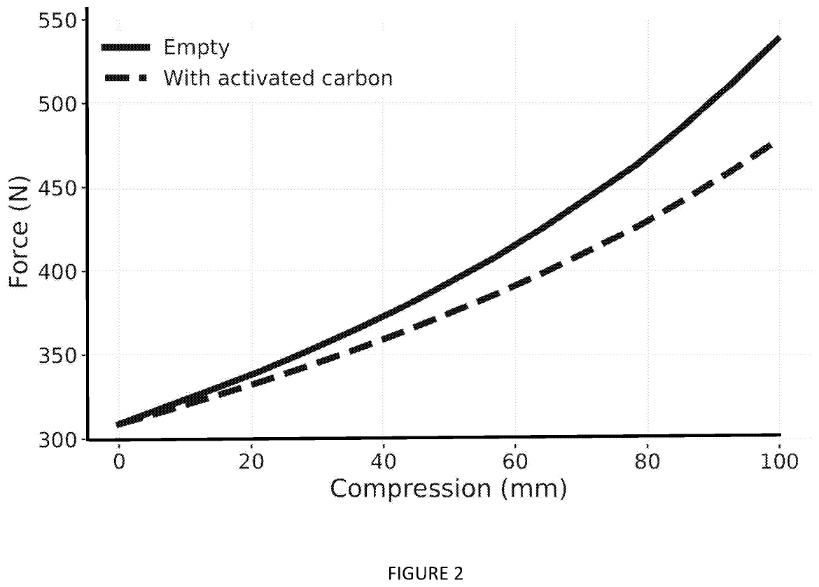

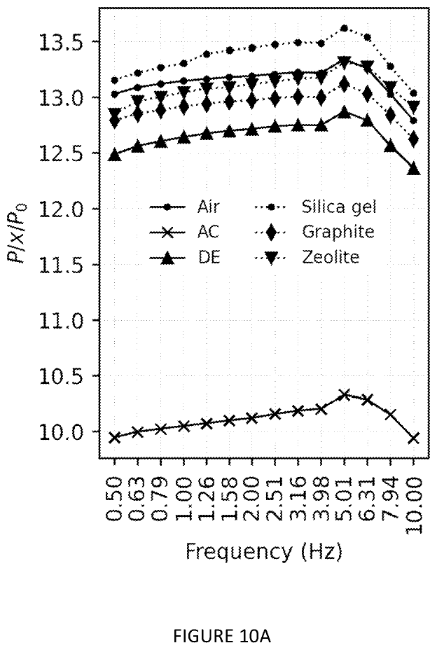

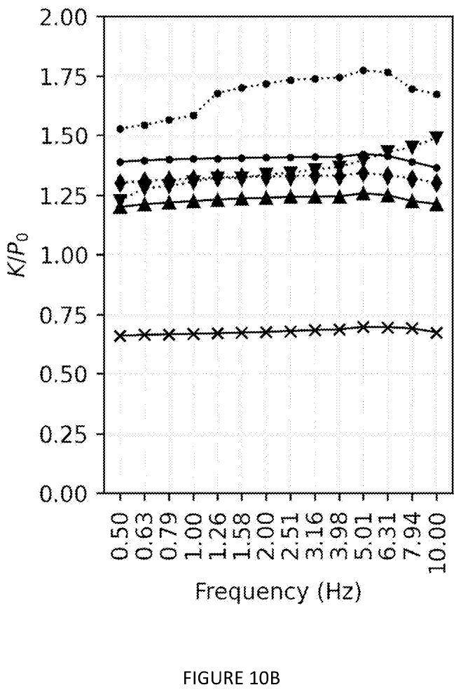

The effect of including portions of activated carbon into a primary pressurised cavity was tested, as described in Experiments 1 to 3 below, using a cylinder rig, illustrated in FIG. 1. Graphs showing the testing results are given in FIGS. 2 to 4 and 10A and 10B.

### EXPERIMENT 1: Determination of the Effect of Adding Activated Carbon to a Primary Storage Chamber

The sample cavity was inflated to a pressure of 2.5 bar, and the piston was driven slowly down the cylinder, with force being measured at regular points along the travel. The rig was kept still for 10 seconds before taking each force measurement reading, to allow any heating from gas compression to dissipate through the cylinder walls. This allowed the creation of a static spring curve, showing the build-up of force against the compression.

The same exercise was repeated with activated carbon granules disposed inside the test chamber. In the test, the activated carbon occupies 33% of the pressurised gas volume at the beginning of the compression cycle.

FIG. 2 shows the build-up of force as the cylinder piston compresses the gas in each case. The solid black line shows the force curve of the system without activated carbon present; the dotted line shows the build-up of force in the system with activated carbon present. In both cases, the pressurised cavity volume and pressure are the same at the start of the test.

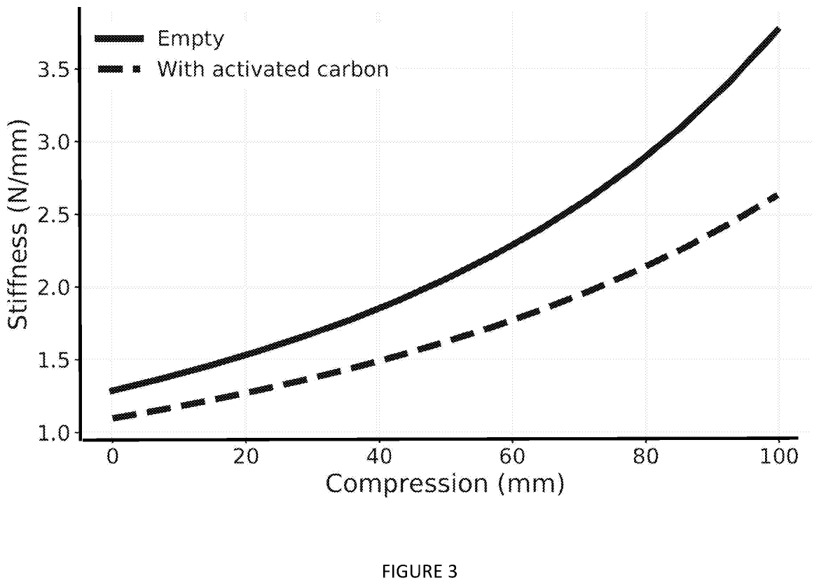

Experiment 1 demonstrates that the use of an adsorbent material reduces the spring rate- or stiffness- of the air or gas in a pressurised cavity. The spring rate of a system is a measure of the rate of change of force, and a lowering of spring rate will result in a reduction in the force curve gradient. A graph of stiffness (N/mm) versus compression (mm) for the results obtained for the setup of Experiment 1 is shown in FIG. 3.

The result of experiment 1 shows that the air inside a cavity is made less stiff by the presence of an adsorbent material. This will mean greater vibration isolation and a lowering of the resonant frequency of the system. However, the sole of a shoe needs a certain degree of stiffness, particularly around its perimeter. The curve from the test also shows that for a given force or loading, the cavity will be compressed by a greater amount if an adsorbent is present. This would mean that the weight of the person wearing the shoes would cause the air sole to compress more, and less travel would be available for a large or heavy shock event- the opposite of what is desired. These problems can be overcome simply by raising the pressure inside the system.

### EXPERIMENT 2: Determination of the Effect Of Increasing The Pressure Inside a Primary Pressurised Gas Container

Experiment 1 was repeated, but this time the pressure in the chamber was raised at the beginning of the compression cycle when activated carbon was inside the test chamber.

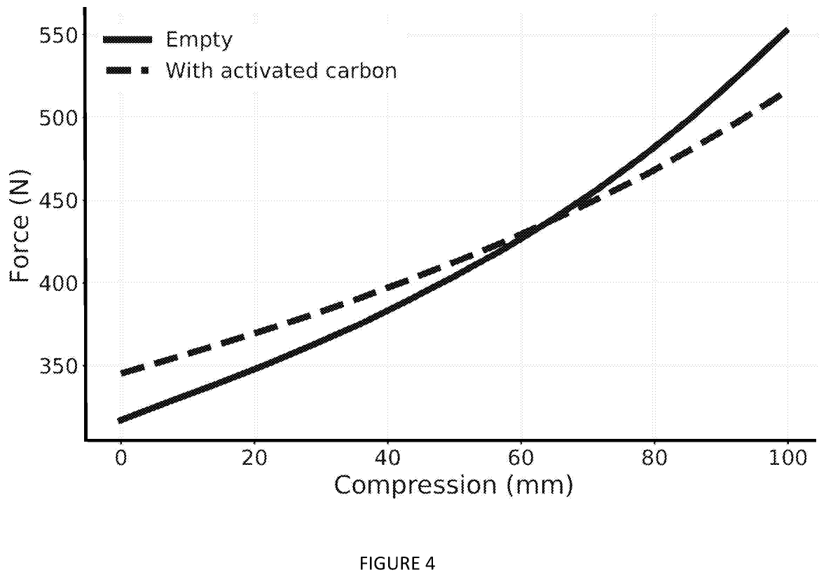

FIG. 4 shows the rise in force in both the empty case at 2.5 bar starting pressure (solid black line) and the chamber containing activated carbon at 3.5 bar starting pressure (dotted line).

The carbon-occupied system exerts greater force at the start of compression by virtue of its higher pressure. But by the end of the travel, the force being exerted by the carbon-occupied system is lower than the empty case at same point in its excursion.

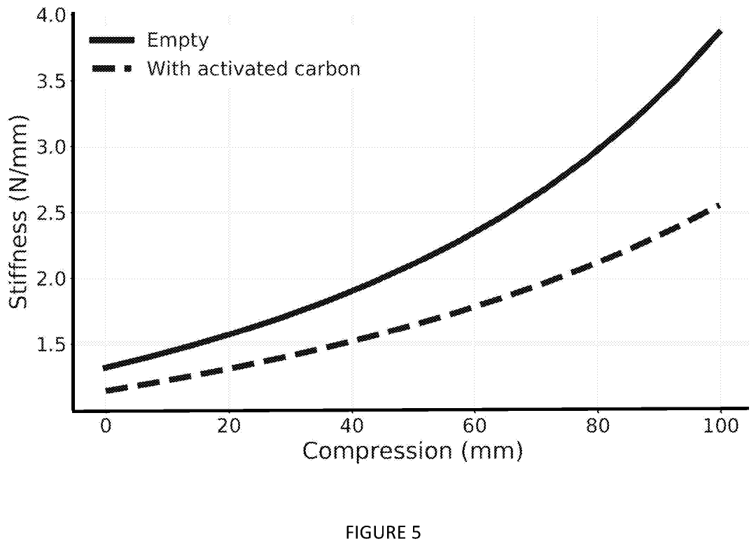

FIG. 5 shows how the spring rate (instead of the force) changes in relation to excursion. The pressure in the chambers is as described above—2.5 bar for the empty case, 3.5 bar for the carbon-occupied chamber. The curve shows that the stiffness of the carbon-occupied chamber being held at higher pressure is similar to the empty chamber at lower pressure at the start of the compression. But as the chambers are compressed, the stiffness of the empty system increases much more quickly with travel than in the carbon-occupied system.

This experiment shows that the pressure inside a carbon-occupied chamber can be tuned to provide similar—if not more—stiffness in small excursions, meaning that under similar loads, both will compress by a similar amount. But with heavier loading- such as a major shock event- the carbon-occupied chamber shall allow a deeper compression.

The consequence of this, in performance terms, is the provision of a cushioned article with similar or greater levels of support in general use but providing far longer compression and greater compliance against heavy impact and shock. In the case of a cushioned article such as an item of footwear or orthotic insert, this means less stress on the foot, ankle, knee and hip, greater protection against fatigue and injury, such as muscle and tendon sprains and stress fractures, and enhanced levels of comfort, all without any loss in running efficiency, lateral or axial support or feel.

### EXPERIMENT 3: Comparison of the Effect Of Different Materials on the Dynamic Bulk Modulus of Air Inside a Primary Pressurised Gas Container.

A test rig similar to that depicted in FIG. 1 was used in this experiment, except that in this version the sample cavity or chamber had a height of 106 mm within a pneumatic cylinder with a 50 mm diameter piston. Test samples as detailed in the table below were inserted in the sample cavity or chamber and the chamber was then pressurised with air to approximately 3 bar, and after waiting sufficient time to allow the pressure to stabilise, the piston was actuated with a sine wave excitation of +−5 mm amplitude at 1/3 band frequencies between 0.5 Hz and 10 Hz. The pressure of the chamber and the displacement of the piston were measured directly.

A control experiment was also performed without a sample of test material i.e. the sample cavity only contained air.

The displacement of the piston from the equilibrium position can be obtained in terms of the pressure and bulk modulus of each material in the cylinder (assuming small displacements relative to the length of the chamber). In the frequency domain (angular frequency ω) that is:

$$x ( ω ) = ( \frac{{d}_{a}}{{K}_{a}} + \frac{{d}_{s}}{{K}_{s}} ) \tilde{p} \qquad ( Equation 1 )$$

where K and d are, respectively, the bulk modulus and thickness of a material; air is indicated by subscript a and the sample under test by subscript s. The pressure relative to the static pressure is used, \tilde{p}=P−P₀, where P is the total pressure and Po the equilibrium static pressure in the cylinder.

The effective fluid bulk modulus of the test sample, Kₛ, is found by rearranging Equation 1:

$${K}_{s} = {d}_{s} ( \frac{x ( ω )}{\tilde{p} ( ω )} + \frac{{d}_{a}}{{K}_{a}} ) \qquad ( Equation 2 )$$

This value is then normalised with respect to the static pressure P₀:

$${K}_{norm} = \frac{K}{{P}_{0}} \qquad ( Equation 3 )$$

A normalised bulk modulus value of 1.4 corresponds to the theoretical dynamic bulk modulus of air (Kₐ=1.4P₀), whereas a value of 1 is the isothermal bulk modulus of air (Kₐ=P₀). Values lower than 1 are achievable by materials such as activated carbon with adsorption working more quickly than a typical compression cycle.

While values lower than 1.4 indicate a reduction in stiffness compared to air, values lower than 1 at in the frequency range of interest (1-50Hz) are only achievable by adsorptive materials with a fast adsorption rate.

RESULTS

| | | | Resulting |
|---|---|---|---|
| | (BET) | | dynamic |
| | Specific | Mean | bulk |
| | Surface | Pore | modulus |
| | area | size | (mean |
| Test sample | (m²/g) | (nm) | value) |
| Control no test sample, air | N/A | N/A | 1.4 |
| only in the pressuried | | | |
| chamber [symbol] | | | |
| Damolex C calcified | **<100 | **up to | 1.23 |
| Diatomaceous Earth 0.2- | | 100 nm | |
| 0.6 mm (RS Minerals Ltd) ▴ | | | |
| Silica gel, non-indicating | 800 | unknown | 1.67 |
| (0.5-1 mm), Geejay | | | |
| Chemicals Ltd [symbol] | | | |
| Macro crystalline graphite | ***<20 | unknown | 1.32 |
| GHL 2790 by Georg Luh | | | |
| GmbH ♦ | | | |
| Zeolite 13X ▾ | 591 | 0.8-1 nm | 1.35 |
| Cabot GCN 3070 Activated | 1513.9 | 1.2 nm | 0.68 |
| Carbon (grain size 30/70) | | | |
| -X- | | | |
| Ingevity (USA) wood based | Unknown | unknown | 0.56 |
| Activated Carbon (AC0007) | (>400) | | |
| Ingevity (USA) wood based | Unknown | unknown | 0.5 |
| Activated Carbon (AC0004) | (>400) | | |
| Haycarb PLC Microporous | 1800 | unknown | 0.4 |
| Activated carbon produced | | | to 0.5**** |
| from coconut shell (grain | | | |
| size 30/70, density | | | |
| 0.38 g/cm³) | | | |

**Typical value for a similar diatomaceous earth material
***Typical value for macrocrystalline graphite materials
****Results inferred from another testing method

### CONCLUSION

Of the various adsorptive materials tested for their ability to reduce the dynamic bulk modulus, or stiffness, of the air inside an air spring, only activated carbon caused a useful difference in io behaviour at the frequencies under consideration. The silica gel actually caused the air in the cavity to become stiffer, because its' low porosity meant it occupied an appreciable proportion of the volume. Further, the silica gel does not absorb air molecules (principally nitrogen) in the quantity or at the speed required to fall within the scope of the present invention. Of the others, only diatomaceous earth and expanded graphite caused any noticeable shift—reducing the bulk modulus from 1.4 down to 1.2 and 1.3 respectively—while the others all gave similar results of around 1.4.

Values lower than 1.4 but higher than 1 are, in principle, achievable by additional heat dissipation alone (provided by the high material surface area in contact with the air) however it is possible that graphite and diatomaceous earth achieved some degree of useful adsorption at these frequencies which may be partly responsible for the result. Activated carbon caused a shift in bulk modulus down to 0.7, well below the theoretical limit for non-adsorptive materials of 1.

### DETAILED DESCRIPTION OF THE INVENTION

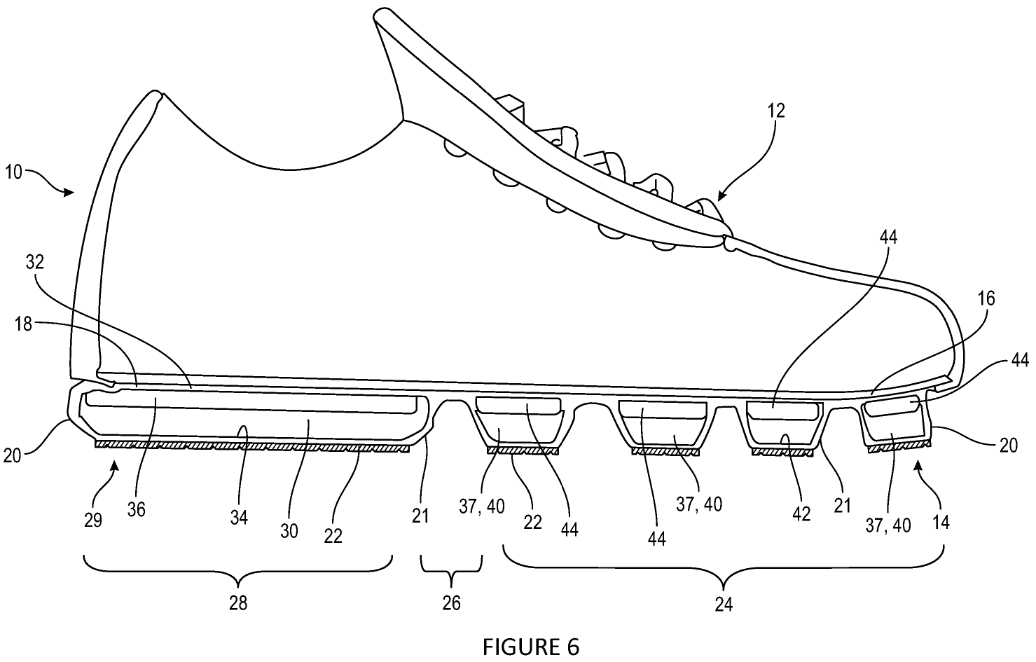

Shoes, and/or parts thereof, with multiple cushioning elements comprising pressurised air contained within pressurised air storage chambers featuring the adsorbed air augmentation of the present invention are illustrated in FIGS. 6 to 9.

Referring to FIG. 6 in detail, a shoe (10) is provided with a shoe upper (12) which helps hold the shoe onto the foot of the wearer, and a sole (14) which is the bottom of the shoe and contacts the ground in use. As shown, the sole (14) has a multi-layered construction, including an insole (16) which is positioned within the upper (12) and which forms the interior bottom of the shoe located directly beneath a footbed (often referred to as a sock liner, not shown), an outsole (20) the outer surface (21) of which has a textured layer (22) provided to increase traction when in direct contact with the ground, and a midsole (18) which is the layer between the outsole (20) and the insole (16). From the front (toe end) to the back (heel end) of the shoe (10), the sole (14) is divided into a forefoot region (24), a midfoot region (26) and a heel region (28). In this example, a cushioning element (29) with a first primary pressurised gas storage heel chamber (30) is formed in the heel between the heel region portion of the midsole (18, 32) and an inner surface (34) of the heel region portion (28) of the outsole (20). The first primary pressurised gas storage chamber (30) contains pressurised gas (for example air above ambient pressure) and a gas adsorbent material (36).

Several further cushioning elements (37), each with a compressed gas storage sole chamber (40), are formed between the forefoot region of the midsole (18, 38) and the inner surface of the forefoot region of the outsole (42). As with the first compressed gas storage heel chamber (30), each of the primary pressurised gas storage sole chambers (40) contain a pressurised gas (for example air above ambient pressure) and a gas adsorbent material (44).

When in use, a force exerted on the sole (14) of the shoe (10) by the foot of the wearer for example during walking, running or jumping, will cause one or more of the primary pressurised gas storage chambers (30, 40) to compress and at least a portion of the pressurised gas contained within said primary pressurised gas storage chambers (30, 40) to be adsorbed by the adsorbent material, and thereby yield an increased compliance in the one or more primary pressurised gas storage chambers, together with an increased shock isolation, compared with the performance of a similar shoe sole structure without any adsorbent material.

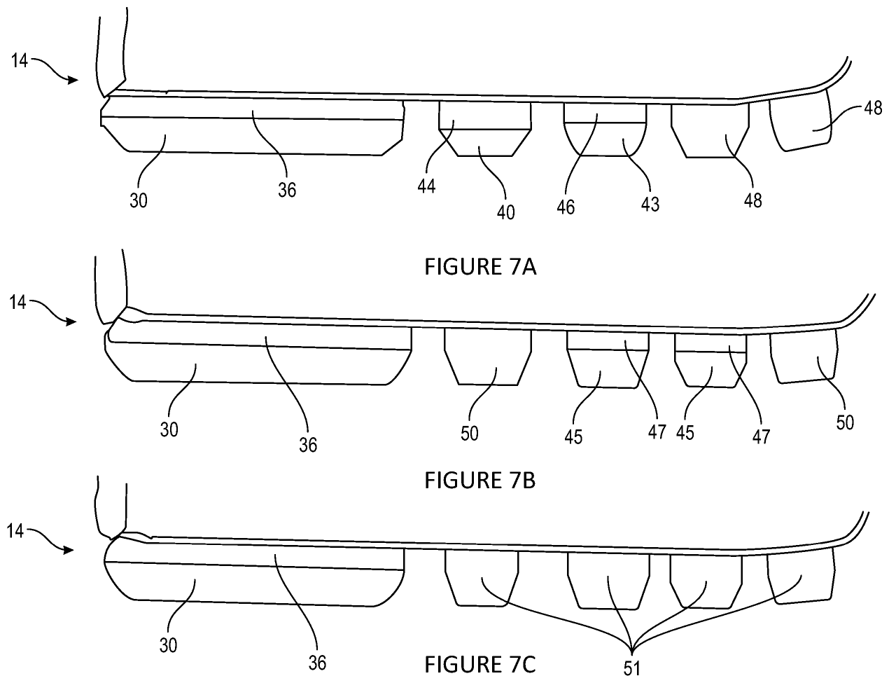

FIGS. 7A, 7B and 7B, show the same sole (14) for the shoe (10) illustrated in FIG. 6 but without the upper (12). However, here the compressed gas storage sole chambers (30, 40, 43, 48) contain different amounts of adsorbent material. For example, FIG. 7A shows one compressed gas storage sole chamber (40) with more adsorbent material (44) than another compressed gas storage sole chamber (43, 46), and other compressed gas storage sole chambers (48) which are empty. FIG. 7B shows two compressed gas storage sole chambers (45) which contain similar amounts of adsorbent material (47) and two compressed gas storage sole chambers (50) which are empty. And FIG. 7C shows all the compressed gas storage sole chambers (51) to be empty.

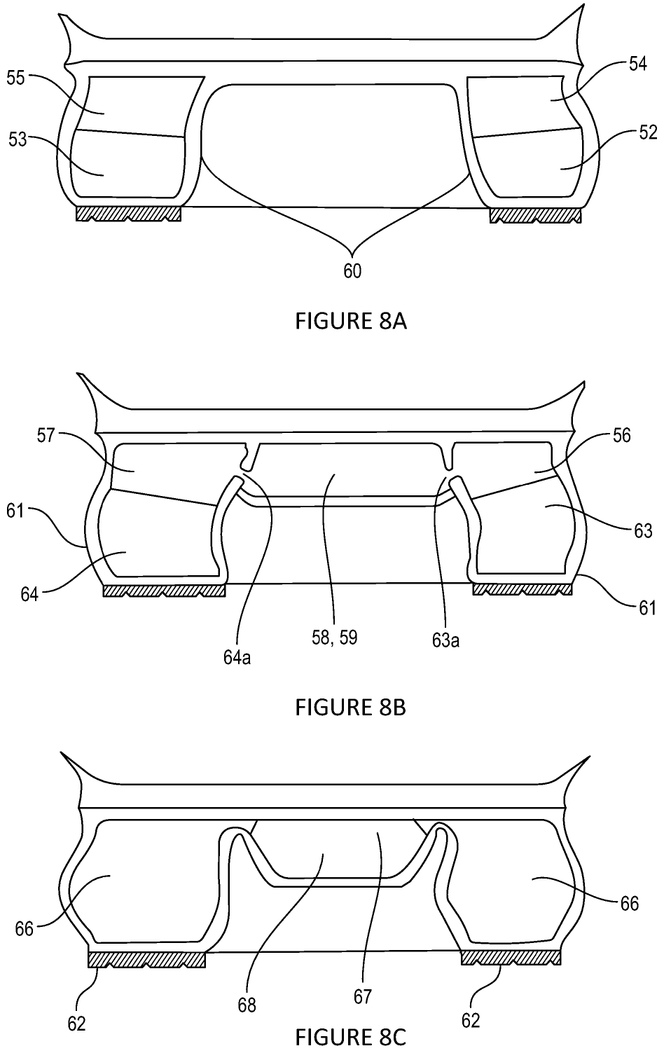

FIGS. 8A to 8C show cross-sectional views of the sole structure of FIG. 6 in a vertical plane through the heel region (28) of the shoe (10) parallel with the transverse axis (i.e. running side to side as opposed to the longitudinal axis which runs front to back or heel to toe) of the shoe (10). Specifically, FIG. 8A shows one version of the sole structure at the heel region of the shoe (10) with a pair of cushioning elements (60) each with a compressed gas sole storage chamber (52, 53) and each with their own independent source of adsorbent material (54, 55). FIG. 8B shows a first alternative version of the sole structure at the heel region of the shoe (10) with a pair of cushioning elements (61) each with a compressed gas sole storage chamber (63, 64) with a respective source of adsorbent material (56, 57), and a secondary chamber (58) filled with adsorbent material (59) and positioned between and, due to the openings (63a, 64a) in the walls which define the compressed gas storage chambers (63, 64), is fluidly communicating with the compressed air contained within the pressurised gas sole storage chambers (63, 64). FIG. 8C shows a second alternative version of the sole structure at the heel region of the shoe (10) with a pair of cushioning elements (62) each with a primary pressurised gas sole storage chamber (66) and a secondary chamber (67) filled with adsorbent material (68) and positioned between and fluidly communicating with the compressed gas contained within the primary pressurised gas sole storage chambers (66).

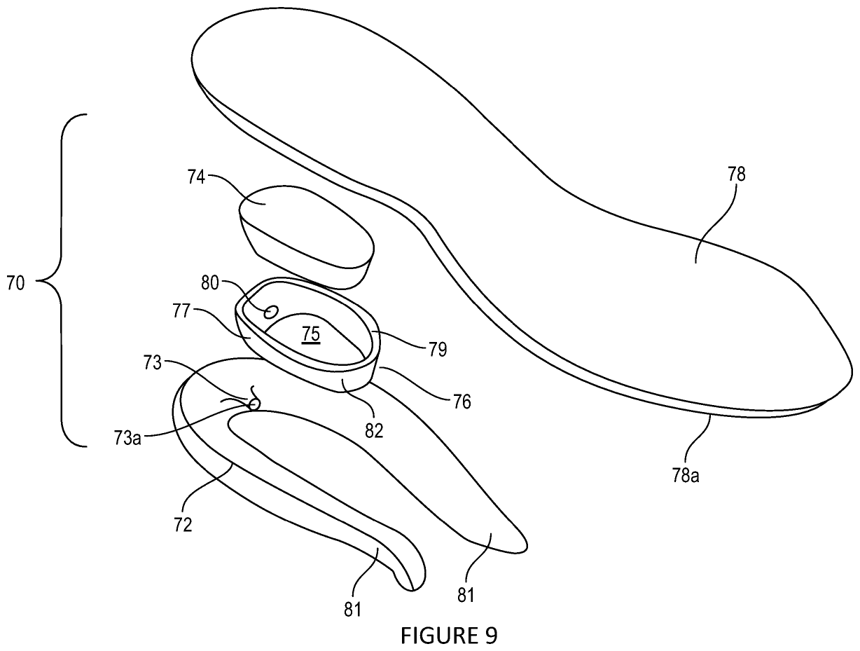

FIG. 9 is an exploded perspective view illustrating the construction of a cushioning element (70) which may be used in the heel region of a different item of footwear to that depicted in

FIG. 6. The cushioning element (70) is formed by a horseshoe-shaped air inflated bladder (72); an adsorbent material monolith (74) that is seated within an adsorbent material retainer (76); and a midsole layer (78). The inflated bladder (72) (made from a pneumatic encapsulation material) includes a hollow protrusion (73) which protrudes from the inflated bladder (72) and has the duel functionality of providing an air inlet/outlet port (via the protrusion opening (72a)) to allow air to pass into and out of the inflated bladder (72), and of providing a first part of a locator means as described below. The adsorbent material retainer (76) is generally cylindrical and is formed by a side wall (82) that has a small aperture (80) therein which forms a second part of the locator means described below. One end of the generally cylindrical retainer (76) is closed by an end wall (75) and the other end of cylindrical retainer (76) has an open end (77) adapted to receive the adsorbent material monolith (74). The open end (77) also has an upper rim surface (79).

The cushioning element (70) is constructed for use in an item of footwear such that the adsorbent material retainer (76) is positioned between two arms (81) of the horseshoe-shaped air inflatable bladder (72) and held in position by the locator means which consists of the hollow protrusion (73) in the bladder (72) being received within the aperture (80) in the side wall (82) in the adsorbent material retainer (76). The adsorbent material (74) is inserted into the adsorbent material retainer (76) via the open end (77) and the upper rim surface (79) of the open end (77) of the retainer (76) is adhered with an airtight seal to the underside (78a) of the midsole (78) to produce a closed pneumatic system. In use, the air within the inflated bladder (72) is in fluid communication with the adsorbent material monolith (74) but is not able to escape into the ambient air.

1. A cushioned article selected from an item of footwear, or orthotic insoles, comprising one or more cushioning elements comprising pressurised gas contained within one or more primary pressurised gas storage chambers, wherein the pressurised gas within the one or more primary gas storage chambers has a normalised bulk modulus of <1.

2. The cushioned article according to claim 1 wherein the pressurised gas is in fluid communication with one or more sources of adsorbent material.

3. The cushioned article according to claim 2 wherein the adsorbent material comprises at least one material selected from one or more zeolites with a specific surface area of >600 m²/g, one or more X-linked polyHIPE materials and one or more activated carbon materials.

4. The cushioned article according to claim 3 wherein the adsorbent material has a mean pore diameter ≥1 nm.

5. The cushioned article according to claim 2 wherein the adsorbent material is in one or more forms selected from granular, powder, felt, un-woven fibre, woven fibre, open-cell foam, self-supporting rigid monolith, self-supporting flexible monolith, porous liquid and high viscosity fluid.

6. The cushioned article according to claim 2 wherein adsorbent material is located within one or more of the primary pressurised gas storage chambers.

7. The cushioned article according to claim 6 wherein the adsorbent material located within a primary pressurised gas storage chamber occupies up to 35% of the volume of the primary pressurised gas storage chamber.

8. The cushioned article according to claim 2 wherein adsorbent material is located within one or more secondary chambers which are separate from the primary pressurised gas storage chamber.

9. The cushioned article according to claim 1 further comprising damping means.

10. The cushioned article to claim 1 wherein the internal pressure of the pressurised gas contained within one or more of the primary pressurised gas storage chambers is from above atmospheric pressure to 5 bar.

11. The cushioned article according to claim 1 wherein at least two of the primary pressurised gas storage chambers are in fluid communication with each other.

12. The cushioned article according to claim 1 wherein the pressurised gas contained within at least one of the primary pressurised gas storage chambers is in exclusive fluid communication with one or more sources of adsorbent material.

13. The cushioned article according to claim 1 comprising two or more sources of adsorbent material which may comprise the same or a different composition of adsorbent materials.

14. The cushioned article according to claim 13 wherein the two or more sources of adsorbent material may comprise adsorbent material with the same chemical composition but in a different amount and/or in a different physical form.

15. The cushioned article according to claim 1 wherein all the one or more primary pressurised gas storage chambers have the same internal pressure.

16. The cushioned article according to claim 1 wherein all the cushioning elements have the same spring rate.

17. The cushioned article according to claim 1 further comprising selective control means to selectively control the fluid communication between any of the one or more cushioning elements.

18. The cushioned article according to claim 1 comprising a layered array of two or more cushioning elements.

19. The cushioned article according to claim 1 wherein the adsorbent material is located within a non-permeable membrane which comprises a degree of microperforation.

20. The cushioned article according to claim 1 comprising a primary pressurised gas storage chamber which has an outer wall surface which provides, or optionally is adapted to provide, a portion of the exterior surface of the cushioned article.

21. The cushioned article according to claim 1, in which the internal pressure of the pressurised gas contained within one or more of the primary pressurised gas storage chambers remains constant in use.

22. The cushioned article according to claim 1, in which one or more of the primary pressurised gas storage chambers are constructed from non-resilient deformable material.

23. The cushioned article according to claim 1, comprising a primary pressurised gas storage chamber formed by a pneumatic encapsulation material with an inner wall surface and an outer wall surface, wherein the inner wall surface is non-resilient.

24. The cushioned article according to claim 1, in which the item of foot wear is selected from the group consisting of a she, such as a sports shoe or a running shoe; a trainer; a ski boot; a snowboard boot; and a walking boot.
